(19) United States
(12) Patent Application Publication
(10) Pub. No.: US 2005/0117473 A1
(43) Pub. Date: Jun. 2, 2005

(54) Method for calibrating a tilt angle of pickup head using a focus signal

(76) Inventors: Shih-Hao Ke, Ta Li City (TW); Hsu-Feng Ho, Tai Pei City (TW); Jia-Hao Lin, Wu Jih Hsiang (TW); Chih-Hsien Kao, Hsin Chu City (TW)

Correspondence Address: BIRCH STEWART KOLASCH & BIRCH, PO BOX 747, FALLS CHURCH, VA, 22040-0747, US

(21) Appl. No.: 10/995,190

(22) Filed: Nov. 24, 2004

(30) Foreign Application Priority Data
Dec. 2, 2003 (TW) 092133889

(51) Int. Cl. G11B 7/00

(52) U.S. Cl. 369/44.32; 369/53.19

(57) ABSTRACT

A method for calibrating a relative tilt angle between a disc and a pickup head using a focus signal. The method includes the steps of moving the pickup head to a first position and performing the focusing operation; obtaining a first variation of a focus signal of the pickup head at a first position; moving the pickup head by a default distance to a second position and performing the focusing operation; obtaining a second variation of the focus signal of the pickup head at a second position; and calculating the relative tilt angle according to the default distance and the first and second variations. The focus signal includes a focus error signal and a focus control signal, both of which have been stored in a control circuit of an optical disc drive. Consequently, the invention utilizes the focus signal to detect the tilt angle of the pickup head without adding any displacement sensor.

This application claims the benefit of the filing date of Taiwan Application Ser. No. 092133889, filed on Dec. 2, 2003, the content of which is incorporated herein by reference.

### BACKGROUND

The invention relates to a method for calibrating a tilt angle of a pickup head, and more particularly to a method for calibrating a tilt angle of a pickup head using a focus signal.

Generally, a pickup head of an optical device needs an actuator to adjust an object lens such that the EFM (Eight to Fourteen Modulation) signals read by the optical device can be robuster. The actuator can precisely move the pickup head to the desired position (angle). However, when the to-be-read or to-be-recorded optical disc is curved or the tilt angle of the pickup head is incorrect, the read or recorded information may be deteriorated. In order to compensate the information for this deterioration, the optical device needs to detect the relative tilt angle between the pickup head and the optical disc and then adjusts the tilt angle of the pickup head at suitable timings.

FIG. 1 shows the architecture of a typical tilt measuring device. As shown in this drawing, the typical tilt measuring device includes a pickup head 10, a tilt detector 13, and an object lens 16. The pickup head 10 is pivoted upon a rotating shaft 18 and rotated under the control of an actuator (not shown). The tilt detector 13 utilizes a light emitter 12 to emit light rays and utilizes optical receivers 14a and 14b to receive the reflected light rays. Thus, the tilt value may be measured according to the signals of the optical receivers 14a and 14b and the actuator is controlled according to the tilt value. This method directly utilizes the relative tilt angle between the pickup head and the optical disk to adjust the tilt angle of the pickup head.

FIG. 2 shows a method for measuring the tilt angle of the pickup head without using a displacement detector. As shown in this drawing, the tilt control module 20 includes a reproduction signal generator 22, a jitter detector 23, a tilt control unit 24, a tilt actuator 25, and a memory 26. The reproduction signal generator 22 is used for converting the RF signal generated by the pickup head into the EFM (Eight to Fourteen Modulation) signal. The reproduction signal generator 22 may be a slicer to slice the RF signal into a digital signal with level 0 or 1. The jitter detector 23 receives the EFM signal and detects the jitter amount of the EFM signal. The typical jitter amount is obtained by calculating the wandering level of the EFM signal. The tilt control unit 24 outputs different tilt values corresponding to different pickup head's tilt values, records the corresponding jitter amounts, and selects the tilt value with minimum jitter amount or the tilt value with jitter amount smaller than a threshold, as the optimum tilt control value for the track. The tilt actuator 25 outputs a drive signal to the optical module 21 to adjust the pickup head's tilt angle according to the tilt control value of the tilt control unit 24. The tilt control value may be a digital signal and stored in the memory 26. In addition, the tilt control value is converted by a digital/analog converter (DAC) and then outputted to the tilt actuator 25. The tilt actuator 25 converts the signal, such as the voltage signal ranging from 0 to 4V, corresponding to the tilt control value into the drive signal for driving the pickup head to rotate.

The above method can adjust the pickup head's tilt angle to the preferred position without using a displacement detector. However, only the optical disk with data can be utilized to calculate the jitter amount of the EFM signal, so as to adjust the pickup head's tilt angle. Thus, the tilt control value for the blank optical disk (i.e., optical disk without data) cannot be adjusted because the EFM signal cannot be obtained.

### SUMMARY

In view of the above-mentioned problems, the invention discloses a method for calibrating a tilt angle of a pickup head in either the blank optical disc or the optical disc with data.

To achieve the above-mentioned object, the method of the invention for calibrating a relative tilt angle between a disc and a pickup head using a focus signal includes the steps of: moving the pickup head to a first position and actuating focus function; obtaining a variation of a focus signal of the pickup head at the first position as a first variation; moving the pickup head by a default distance to a second position and actuating the focus function; obtaining a variation of the focus signal of the pickup head at the second position as a second variation; and calculating the relative tilt angle according to the default distance, the first variation and the second variation.

The focus signal includes a focus error signal and a focus control signal, both of which have been stored in a control circuit of an optical disc drive. Consequently, the invention utilizes the focus signal to detect the tilt angle of the pickup head without adding any displacement sensor.

### BRIEF DESCRIPTION OF THE DRAWINGS

FIG. 1 shows the architecture of a conventional tilt adjusting device.

FIG. 2 shows a schematic architecture for adjusting a tilt angle of a pickup head without any displacement sensor.

FIG. 3 shows a schematic illustration of positions of the pickup head and the optical disc after the focusing process.

FIG. 4 shows a schematic illustration of a calibration sheet.

FIG. 5A shows a focus error signal FE measured in a known track T2, and

FIG. 5B shows a focus control signal FCS measured at the know track T2.

FIG. 6 is a flow chart showing a method of the invention for calibrating a tilt angle of a pickup head using a focus signal.

FIG. 7 shows a schematic illustration using a low-pass filter to obtain a focus signal.

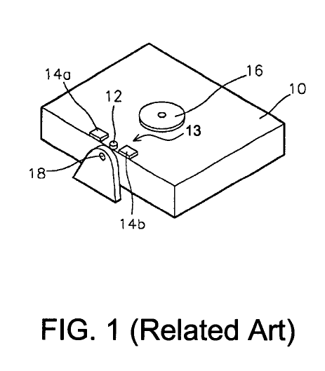

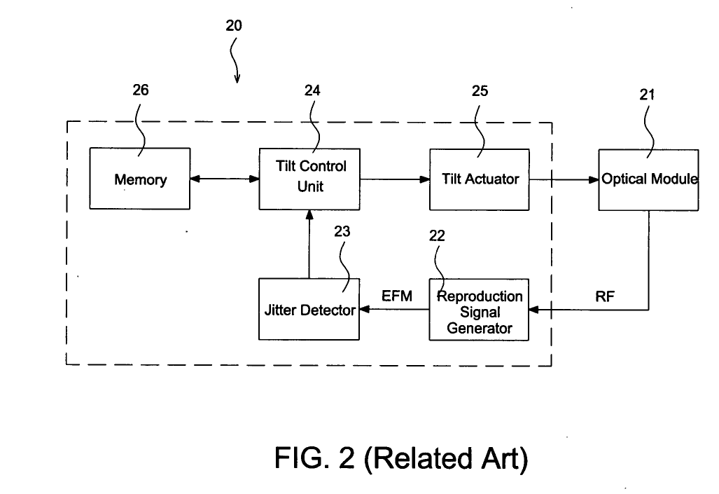

### DETAILED DESCRIPTION

The method of the invention for calibrating a tilt angle of a pickup head using a focus signal will be described with reference to the accompanying drawings.

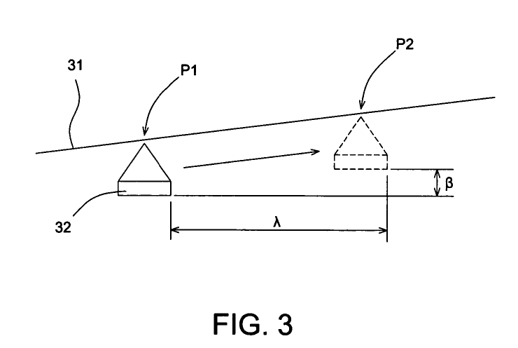

FIG. 3 shows a schematic illustration of positions of the pickup head and the optical disc after the focusing process. As shown in FIG. 3, a fixed distance is kept between a pickup head 32 and an optical disc 31 after the focus control procedure. That is, after the focus control mechanism is actuated, the optical disc drive outputs a focus control signal (FCS) to control the up/down movements of a lens of the pickup head according to the focus error signal (FE signal) such that the fixed distance is held between the lens of the pickup head and the optical disc 31. Consequently, as shown in FIG. 3, no matter how positions P1 or P2 the pickup head 32 is moved to, the relative distance between the lens of the pickup head 32 and the optical disc 31 is fixed. The invention utilizes this property to calculate the relative tilt angle between the pickup head 32 and the optical disc 31 according to the distance λ between the positions P1 and P2, and the lens moving distance β between the positions P1 and P2. If the distance from the position P1 to position P2 is not long, the positions P1 and P2 of the optical disc may be regarded as a straight line. So, the tilt angle may be calculated by:

$$θ = {tan}^{- 1} ( \frac{β}{λ} ) \qquad ( 1 )$$

When the carriage of the pickup head 32 is controlled by a DC servo motor, the distance λ between the positions P1 and P2 may be obtained according to the track-crossing number and the track pitch of the pickup head. For example, the existing CD standard has the track pitch ranging from 1.5 to 1.7 μm, and the real track pitch may be calibrated after the optical disc is placed into the optical disc drive. The calibrating method may be found in the prior art, and detail descriptions thereof will be omitted. Therefore, when each track pitch is obtained, the distance λ between the positions P1 and P2 can be calculated according to the track-crossing number and the track pitch. In addition, when the carriage of the pickup head is controlled by a stepping motor, the distance λ between the positions P1 and P2 also may be obtained according to the stepping signal of the stepping motor for driving the carriage of the pickup head 32. For example, the pickup head 32 is moved by 3 mm, which may be obtained during the mechanism design phase as the stepping motor rotates one cycle. If the motor rotates one cycle after 50 stepping signals are sent, then we know that one stepping signal can move the pickup head 32 by 3/50=0.06 mm. So, the so-called track displacement may be obtained according to the sent stepping signal multiplied by the displacement of the pickup head 32 that is moved according to one stepping signal.

Next, the lens moving distance β between the positions P1 and P2 may be obtained according to the focus control signal FCS or the focus error signal FE. That is, the relationship between the focus control signal FCS or focus error signal FE and the lens moving distance β may be obtained before the optical disc drive is shipped out. Then, the relationship is utilized to calculate the lens moving distance β according to the value of the focus control signal FCS or focus error signal FE. How the relationship between the focus control signal FCS or focus error signal FE and the lens moving distance β will be obtained will be described in the following.

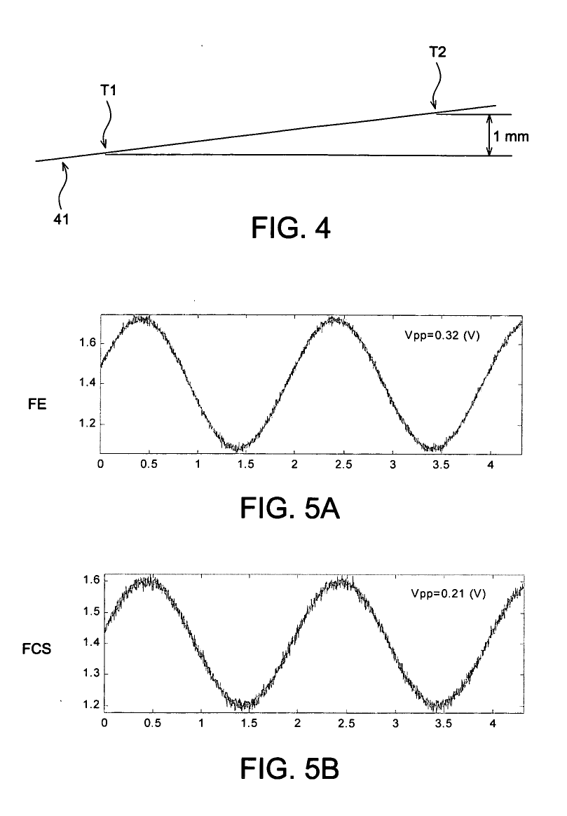

First, a calibration optical disc having a curved angle, which is already known, is designed. For example, FIG. 4 shows a schematic illustration of a calibration optical disc. As shown in FIG. 4, the calibration optical disc 41 has two track positions T1 and T2 that are already known, and the height difference (e.g., 1 mm) between the track positions is also known. Then, the calibration optical disc 41 is placed into the optical disc drive, and the variations of the focus error FE and the focus control signal FCS caused by the calibration optical disc 41 at the known track positions T1 and T2 are measured. The variation may be measured by the ADC. FIG. 5A shows a focus error signal FE measured in a known track position T2, and FIG. 5B shows a focus control signal FCS measured at the know track position T2. As shown in FIG. 5A, the variation of the focus error signal FE is 0.32V. As shown in FIG. 5B, the variation of the focus control signal FCS is 0.21V. If the peak-to-peak values of the focus error signal FE and the focus control signal FCS measured at the known track position T1 are 0.5 and 0.4, the variations of the focus error signal FE and the focus control signal FCS at the known track positions T1 and T2 are 0.27V and 0.17V, respectively. Hence, the ratio between the lens moving distance β and the focus error signal FE is 3.704 (mm/V), and the ratio between the lens moving distance β and the focus control signal FCS is 5.882 (mm/V). So, as long as the individual voltage differences between the focus error signal FE or focus control signal FCS at two track positions are known, the up/down displacement of the lens of the pickup head may be obtained.

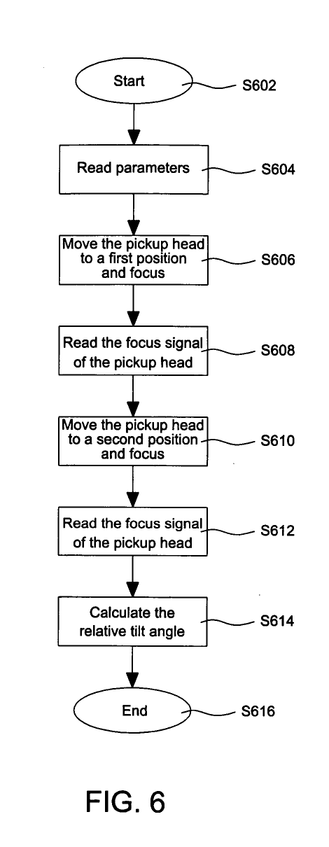

FIG. 6 is a flow chart showing a method of the invention for calibrating a tilt angle of a pickup head using a focus signal. As shown in FIG. 6, the method of the invention for calibrating the tilt angle of the pickup head using the focus signal includes the following steps.

Step S602: start.

Step S604: read parameters (i.e., to read the ratio of the variation to the lens displacement from the optical disc drive) so as to calculate the lens displacement between different positions according to the ratio. The ratio of the variation to the lens displacement may be inputted to the optical disc drive before the optical disc drive is shipped out.

Step S606: move the pickup head to a first position and actuate the focus control mechanism.

Step S608: read the focus signal of the pickup head at the first position and calculate the first variation thereof. The focus signal may be the focus error signal FE or focus control signal FCS, and the variation may be a peak-to-peak value.

Step S610: move the pickup head to a second position by a default distance λ and actuate the focus control mechanism.

Step S612: read the focus signal of the pickup head at the second position and calculate the second variation thereof. The focus signal may be the focus error signal FE or focus control signal FCS, and the variation may be the peak-to-peak value. Of course, the focus signals at the first position and the second position have to be the same. That is, both of the focus signals have to be the focus error signal FE or the focus control signal FCS.

Step S614: calculate the relative tilt angle θ. The lens displacement β is calculated according to the variation difference between the first variation and the second variation as well as the ratio of the variation to the lens displacement. That is, the lens displacement β is the product of the variation difference and the ratio. Thereafter, the relative tilt angle θ is calculated according to the lens displacement β and the default distance λ and to the following equation:

$$θ = {tan}^{- 1} ( \frac{β}{λ} ) \qquad ( 2 )$$

Step S616: end.

Consequently, every time when the optical disc is placed into the optical disc drive, the method of the invention may be utilized to calculate the relative tilt angle between the inner tracks and the outer tracks. Thereafter, the optical disc drive can read or write the disc in a stabler manner using the calculated tilt angle to calibrate the tilt angle of the pickup head. How to control the tilt angle of the pickup head of the optical disc drive according to the tilt angle is well know in the art.

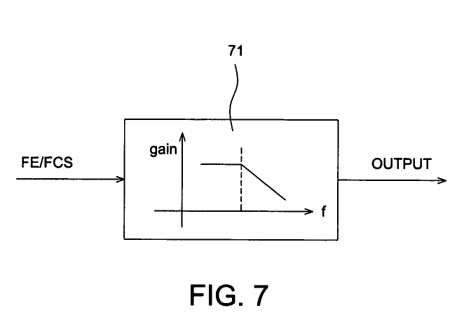

FIG. 7 shows a schematic illustration using a low-pass filter to obtain a focus signal. As shown in FIG. 7, the invention utilizes a low-pass filter 71 to receive the focus signal and outputs a filtering signal after filtering the noise of high-frequency components. Because the focus signal typically has noise, corrected data may be obtained using the low-pass filter to filter the noise of high-frequency components and get the DC offset of the focus signals. How to acquire the DC offset value of the signal is well know in the art, and detailed descriptions thereof will be omitted.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

1. A method for calibrating a tilt angle of a pickup head using a focus signal, the method comprising the steps of:
moving the pickup head to a first position on a disc and actuating focus function;
reading a variation of the focus signal of the pickup head at the first position as a first variation;
moving the pickup head by a default distance to a second position on the disc and actuating the focus function;
reading a variation of the focus signal of the pickup head at the second position as a second variation; and
calculating the relative tilt angle according to the default distance, the first variation and the second variation.

2. The method according to claim 1, further comprising the step of reading a ratio of the variation to a lens displacement.

3. The method according to claim 2, wherein in the step of calculating the relative tilt angle, a difference between the first variation and the second variation and the ratio of the variation to the lens displacement is used to calculate up/down displacements of a lens of the pickup head at the first position and the second position.

4. The method according to claim 3, wherein in the step of calculating the relative tilt angle, the relative tilt angle θ is calculated by:
$$θ = {tan}^{- 1} ( \frac{β}{λ} )$$
wherein β is the up/down displacement of the lens, and λ is the default distance.

5. The method according to claim 1, wherein the focus signal is a focus error signal.

6. The method according to claim 5, wherein the variation is DC offset of the focus error signal caused by tilt of the disc.

7. The method according to claim 6, wherein the DC offset of the focus error signal is filtered out high frequency components to improve the reliability.

8. The method according to claim 1, wherein the focus signal is a focus control signal.

9. The method according to claim 7, wherein the variation is DC offset of the focus error signal caused by tilt of the disc.

10. The method according to claim 9, wherein the DC offset of the focus error signal is filtered out high frequency components to improve the reliability.
